(19) United States
(12) Patent Application Publication
(10) Pub. No.: US 2018/0060905 A1
(43) Pub. Date: Mar. 1, 2018

(54) MEDIA RESOURCE SYSTEMS AND METHODS FOR PROVIDING CONTENT OWNER REVENUE

(71) Applicants: Jordan Byman, Calgary (CA); Sean Fournier, Calgary (CA); René Fournier, Calgary (CA)

(72) Inventors: Jordan Byman, Calgary (CA); Sean Fournier, Calgary (CA); René Fournier, Calgary (CA)

(21) Appl. No.: 15/246,496

(22) Filed: Aug. 24, 2016

(51) Int. Cl. G06Q 30/02

(52) U.S. Cl. CPC G06Q 30/0246; G06Q 30/0273

(57) ABSTRACT

A method for collecting and reporting media information, comprising: a) computing media time duration consumption data by the media computing platform independently for each one or more media resources consumed by each one or more user devices; b) receiving a media rating by the media computing platform for each one or more media resources consumed by each one or more user devices; c) calculating an enjoyment score by the media computing platform from the media time duration consumption data and the media rating independently for each one or more media resources consumed by each one or more content owner devices; d) calculating a media payout by the media computing platform for each content owner for each one or more media resources from the enjoyment score.

### FIELD OF THE INVENTION

The present disclosure is in the field of methods and/or systems for calculating content owner revenue relative to media enjoyment.

### BACKGROUND OF THE DISCLOSURE

Since the advent of the internet media consumption has been derived from many entities and organizations that have their own websites. Generally, media such as radio stations, live podcasts, videos and audio files, and other sources of media have their own separate website or software application to allow consumers to access their media.

However, even if a website or software application receives a lot of traffic, content owners are still faced with the problem of turning that traffic into a stream of revenue. Today, podcasters and the advertisers who support them also face a problem with a lack of visibility into the metrics of how many consumers are actually listening to their media, and what portions of a media resource (if at all, after downloading), consumers are consuming.

### SUMMARY OF THE INVENTION

Disclosed herein is a method for collecting and reporting media information, comprising: a) receiving one or more media resources by a media computing platform from one or more content owner devices; b) consuming one or more media resources via the media computing platform and one or more user devices; c) computing media time duration consumption data by the media computing platform independently for each one or more media resources consumed by each one or more user devices of Step b), wherein computing by a processor derives an independent time duration measure of a user's consumption of each media resource; d) reporting media time duration consumption data by the media computing platform independently for each one or more media resources consumed by each one or more user devices of Step c); e) receiving a media rating by the media computing platform for each one or more media resources consumed by each one or more user devices of Step d); f) reporting the media rating by the media computing platform for each one or more media resources consumed by each one or more user devices of Step e); g) calculating an enjoyment score by the media computing platform from the media time duration consumption data of Step d) and the media rating of Step f) independently for each one or more media resources consumed by each one or more content owner devices; h) calculating a media payout by the media computing platform for each content owner for each one or more media resources from the enjoyment score of Step f); and i) reporting the media payout by the media computing platform for each content owner's one or more media resources from the calculated media payout of Step h).

In another aspect, disclosed herein is a system for collecting and reporting media information, comprising: a) a processor; b) a storage device; and c) a media computing platform, comprising: i) a consumer media consumption and rating functionality configured to be operated by the processor and stored on the storage device for computing and reporting media time duration consumption data for one or more media resources for one or more users, and for receiving and reporting a media rating for one or more media resources from one or more users; and ii) a content owner media payout functionality configured to be operated by the processor and stored on the storage device for computing and reporting one or more media payouts determined by a media enjoyment score derived from the consumer media consumption and rating functionality.

### BRIEF DESCRIPTION OF THE DRAWINGS

FIG. 1 is a flowchart of a method and system for collecting and reporting media information 100.

FIG. 2 is a flowchart of a method for collecting and reporting media information 200.

FIG. 3 is a illustration of an example of a media payout report 300.

FIG. 4 illustrates a schematic block diagram of a conceptual computer system 400 used to implement some embodiments. For example, the system described above in reference to FIGS. 1-3 may be at least partially implemented using computer system 400.

### DETAILED DESCRIPTION OF THE EMBODIMENTS

The following is a detailed description of certain specific embodiments of methods and systems for collecting and reporting media information as disclosed herein.

In one aspect, disclosed herein is a method for collecting and reporting media information, comprising: a) receiving one or more media resources by a media computing platform from one or more content owner devices; b) consuming one or more media resources via the media computing platform and one or more user devices; c) computing media time duration consumption data by the media computing platform independently for each one or more media resources consumed by each one or more user devices of Step b), wherein computing by a processor derives an independent time duration measure of a user's consumption of each media resource; d) reporting media time duration consumption data by the media computing platform independently for each one or more media resources consumed by each one or more user devices of Step c); e) receiving a media rating by the media computing platform for each one or more media resources consumed by each one or more user devices of Step d); f) reporting the media rating by the media computing platform for each one or more media resources consumed by each one or more user devices of Step e); g) calculating an enjoyment score by the media computing platform from the media time duration consumption data of Step d) and the media rating of Step f) independently for each one or more media resources consumed by each one or more content owner devices; h) calculating a media payout by the media computing platform for each content owner for each one or more media resources from the enjoyment score of Step f); i) reporting the media payout by the media computing platform for each content owner's one or more media resources from the calculated media payout of Step h); and j) calculating a media platform payout by the media computing platform derived from a percentage of a user's subscription fee.

Disclosed herein are methods and a system for apportioning revenue to a content owner based on a consumer's or user's relative enjoyment of a content owner's media relative to their enjoyment of media from other content owners. The “Enjoyment Score” may be defined as a function of two criteria: (1) the consumer's media rating of the media relative to a consumer's media rating of each media resource from other content owners; and (2) the consumption of media by a consumer relative to the consumer's consumption of media from other content owners. The consumer purchases a subscription or access to the media from a media computing platform via a computer enabled network. The media is provided to the media computing platform by content owners. The media can be, but is not limited to, audio, video, text and games, etc. As the consumer accesses media resources, the consumer's enjoyment of the media is measured and collected by the media computing platform. The “Enjoyment Score” may be derived from: (1) the media rating the consumer gives to each media resource the consumer has consumed; and (2) the length of time the consumer listens, watches, reads, plays or experiences each media resource.

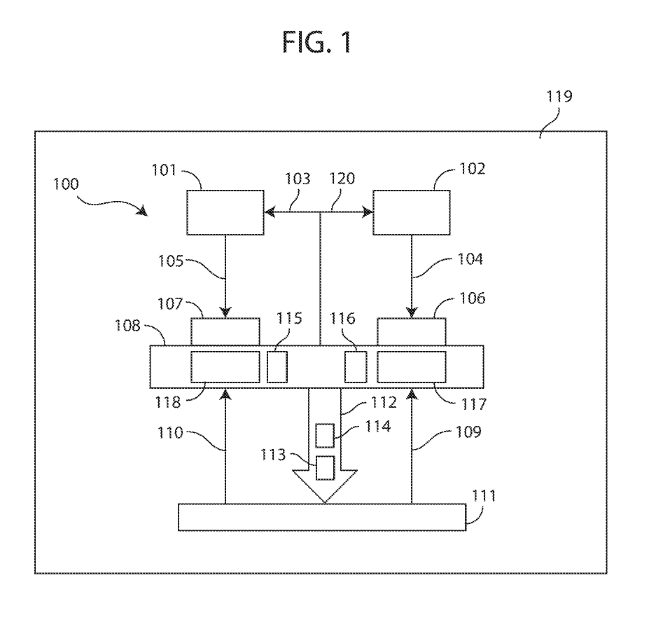

Turning to the drawings, FIG. 1 is a flowchart of a method and/or system for collecting and reporting media information 100, comprising one or more content owner devices 101, 102 . . . and one or more consumers 111 in communication over a network 119 with a media computing platform 108, whereby the media computing platform 108 may be accessed by content owner devices and user devices. In some embodiments, the device comprises a set-top box coupled to a respective television unit, desktop computer, cell phone, computer tablet and/or a smart television. FIG. 1 further illustrates that the media computing platform 108 comprises a processor 115, a storage device 116, consumer media consumption and rating functionality 118 and content owner media payout functionality 117. In some embodiments, the method for collecting and reporting media information further comprises one or more machine readable storage media storing machine readable instructions for implementing the functionality of the method for collecting and reporting media information. The system for collecting and reporting media information 100 is in content owner communications 104, 105 . . . with one or more content owners 101, 102 . . . , whereby content owners register with the media computing platform 108 and upload media resources 106, 107, . . . to the media computing platform 108. In some embodiments, the media computing platform is configured for receiving and reporting via a network to a remote operator, consumer and/or user. In some embodiments, the media resource is selected from video files, photos, books, audio files, video games, virtual reality and/or augmented reality. In some embodiments, the media resource is live media and/or recorded media. In some embodiments, the media resource is a television program, movie, audio book and/or video game. In this aspect, content owners may upload computer, cell phone, computer tablet, and/or television enabled audio or video files, games and/or books, etc. Consumer may register or subscribe 110 with the media computing platform 108, whereby the consumer or user pays a subscription fee in order to access all the media resources on the media computing platform 108. In some embodiments, the method for collecting and reporting media information further comprises the step of receiving a user's registration and subscription fee. Moreover, the consumer or user may access the media resources via media computing platform's 108 application, cell phone application and/or website in order to consume one or more media resources 113, 114 . . . . As the consumer or user consumes media resources the media computing platform 108 receives a rating for one or more media resources from the consumer via the network and the media computing platform 108 reports the media rating. Secondly, the media computing platform 108 tracks the length of time the consumer or user consumes each media resource. The media computing platform 108 calculates how much of the consumer's remaining subscription fee is apportioned to content owners whose media the consumer or user consumed using an enjoyment algorithm. The result is that the media computing platform 108 calculates media payouts 103, 120 . . . , to individual content owners and/or content providers based on the results from calculating an enjoyment score by the media computing platform from the media time duration consumption data and the media rating. At the end of the consumer's subscription period, the media computing platform 108 may optionally deduct a portion of the consumer's subscription as a media computing platform operating portion.

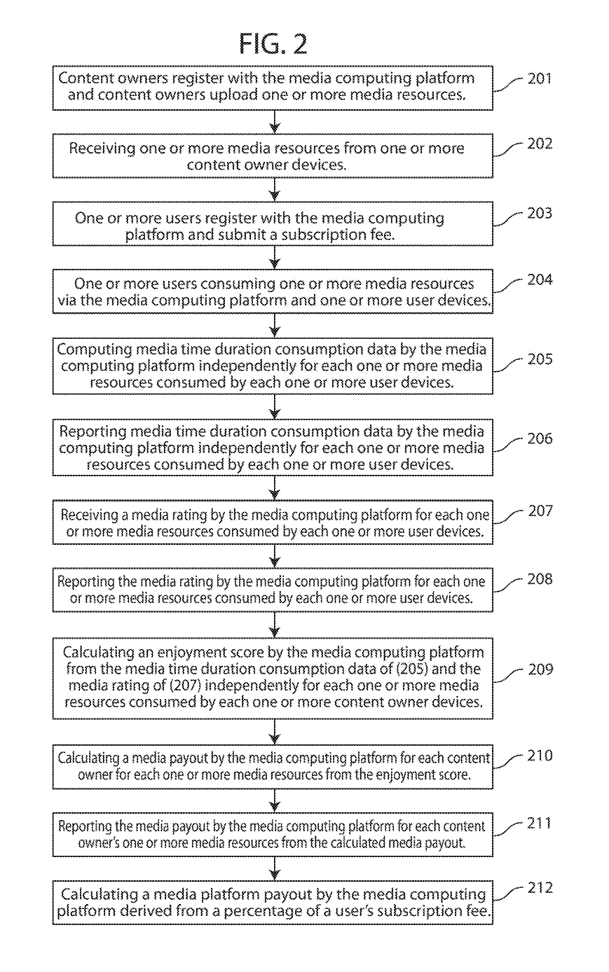

Turning to FIG. 2, the flowchart provides a stepwise embodiment of the method for collecting and reporting media information, wherein one or more method steps 201, 202, 203, 204, 205, 206, 207, 208, 209, 210, 211 and/or 212 may be optional. Initially, content owners register with the media computing platform 108 and upload media resources. The media computing platform 108 receives media resources from each content owner registered with the system. Consumers or users register with the media computing platform 108 and submit a subscription fee for access to all media resources derived from media resources uploaded from the content owners to the media computing platform 108. As a consumer or user consumes a media resource the media computing platform 108 tracks the amount of time each media resource is consumed as media time duration consumption data in the form of time segments calculated in milliseconds, seconds, minutes, hours, or a combination thereof. The media time duration consumption data for each media resource for each content owner is stored. The media computing platform 108 may report the media time duration consumption data to operators of the media computing platform 108 and/or each content owner relative to each content owner's media resource. Consumers or users transmit ratings to the media computing platform 108 for each media resource consumed for each content owner's media resource, whereby the media rating may be stored and reported to operators of the media computing platform 108 and/or each content owner. In some embodiments, consumers and/users transmit one or more media ratings to the media computing platform for each media resource consumed. The media computing platform 108 employs an enjoyment algorithm to provide an enjoyment score from the media time duration consumption data and media rating for each media resource consumed for each content owner's media resource. In this aspect, the enjoyment score for each content owner's media resource is used to derive a media payout to each content owner relative to each media resource consumed by a consumer or a user.

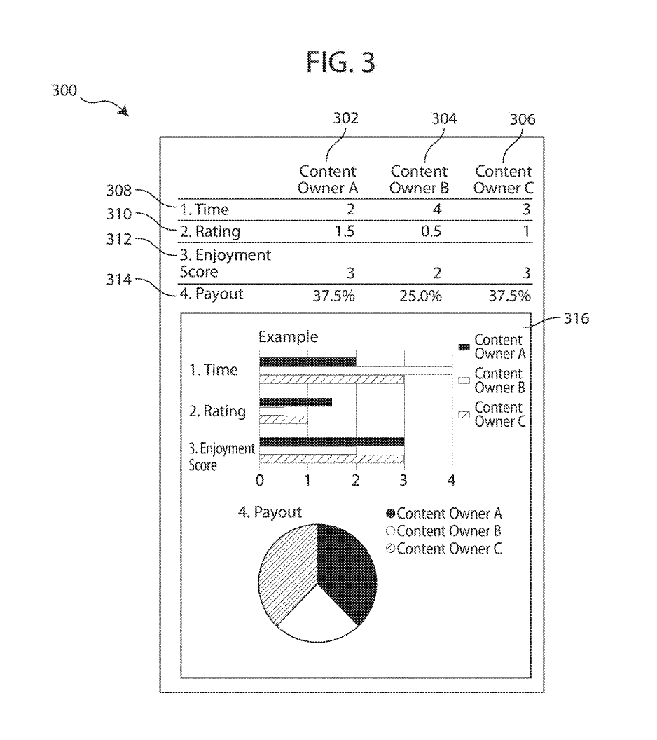

The method for collecting and reporting media information allows content owners to view reports on how many people are listening, playing or viewing the content owner's media and/or receive live media information as disclosed herein as the consumer is consuming the media resource. In some embodiments, a content owner may receive a timeline of how many consumers consumed the content owner's media resource(s) in days, weeks and/or years. FIG. 3 is an example of a media payout report 300 comprising a plurality of content owners 302, 304, 306 . . . , in the form of a graphic chart and table of associated data for media resources consumed. In some embodiments, the one or more media ratings is/are tracked relative to media time duration consumption data collected to afford one or more media rating time points whereby the user's device transmitted the media rating. In some embodiments, the one or more media rating time points are in the form of time segments calculated in milliseconds, seconds, minutes, hours, or a combination thereof. The report shows media time duration consumption data 308 for each content owner relative each content owner's media resource. In some embodiments, the consumer media consumption and rating functionality is configured to generate media time duration consumption data in the form of one or more time segments of one or more media resources consumed by one or more users. In some embodiments, the one or more time segments are calculated in milliseconds, seconds, minutes, hours, or a combination thereof. In this example, the consumer or user transmitted a media rating 310 for each content owner's media resource consumed. Using a computer derived enjoyment algorithm, the media computing platform 108 calculates an enjoyment score 310, which is used to calculate a media payout 314 to each content owner relative to their media resource consumed by a consumer or user. In some embodiments, the consumer media consumption and rating functionality is configured to receive media ratings in the form of a numerical rating from one or more users for one or more media resources. In some embodiments, the numerical rating is between 1 and 100. In the example, the report 300 details a single consumer or user's consumption media resources from three content owners, the resulting enjoyment score and what percentage of the consumer's subscription revenue content owners are owed. In the example, while the consumer experienced content owner B's media for a longer duration, the consumer rated it lower than the media from content owner A's media resource, resulting in a lower enjoyment score. As displayed, the payout to each content owner varies with the data collected for their respective media resource consumed by the consumer or user. Moreover, the media payout 314 is a percentage of a consumer's or user's subscription fee. The apportioning of revenue to a content owner derived from the consumer subscription is based upon the consumer's relative enjoyment score of each media resource relative to his enjoyment score derived from media resources from other content owners as depicted in FIG. 3. Actual enjoyment of media with the result of an enjoyment score is tracked and collected. In this aspect, not merely downloads, streams or the duration of listening, watching, playing and/or experiencing media is tracked and collected. Relative enjoyment between different content owners provides a relative weight by which the consumer's subscription fee is apportioned to the content owner(s). The invention is media-agnostic and may be applied to live or recorded media including, but not limited to, audio, video, text and games.

The enjoyment algorithm fairly apportions subscription revenue to content owners based on consumer's enjoyment of their media as derived from the enjoyment score. The enjoyment algorithm is applied to each consumer or user. In a given subscription period, the consumer consumes listens to, watches, plays, reads or otherwise experiences media from one or more content owners, whereby the consumer rates his enjoyment of each media. The enjoyment algorithm uses the consumer's media rating of media resources consumed and the duration of the consumption to calculate the relative enjoyment score. The enjoyment score fairly determines the relative payout to each content owner.

In another aspect, disclosed herein is a system for collecting and reporting media information, comprising: a) a processor; b) a storage device; and c) a media computing platform, comprising: i) a consumer media consumption and rating functionality configured to be operated by the processor and stored on the storage device for computing and reporting media time duration consumption data for one or more media resources for one or more users, and for receiving and reporting a media rating for one or more media resources from one or more users; and ii) a content owner media payout functionality configured to be operated by the processor and stored on the storage device for computing and reporting one or more media payouts determined by a media enjoyment score derived from the consumer media consumption and rating functionality, wherein the media resource is selected from video files, audio files and/or video games.

In some embodiments, the system for collecting and reporting media information comprises that the media resource is a television program, movie, audio book and/or video game.

In some embodiments, the system for collecting and reporting media information comprises that the device comprises a set-top box coupled to a respective television unit, desktop computer, cell phone, computer tablet and/or a smart television.

In some embodiments, the system for collecting and reporting media information comprises that the consumer media consumption and rating functionality is configured to generate media time duration consumption data in the form of one or more time segments of one or more media resources consumed by one or more users.

In some embodiments, the system for collecting and reporting media information comprises that the one or more time segments are calculated in milliseconds, seconds, minutes, hours, or a combination thereof.

In some embodiments, the system for collecting and reporting media information comprises that the consumer media consumption and rating functionality is configured to receive media ratings in the form of a numerical rating from one or more users for one or more media resources.

In some embodiments, the system for collecting and reporting media information comprises that the numerical rating is between 1 and 100.

In some embodiments, the system for collecting and reporting media information comprises that the one or more media ratings is/are tracked relative to media time duration consumption data collected to afford one or more media rating time points whereby the user's device transmitted the media rating. In some embodiments, the one or more media rating time points are in the form of time segments calculated in milliseconds, seconds, minutes, hours, or a combination thereof.

In some embodiments, the media computing platform is configured for receiving and reporting via a network to a remote operator or user. In some embodiments, the system for collecting and reporting media information further comprises one or more machine readable storage media storing machine readable instructions for implementing the functionality of the system for collecting and reporting media information.

### Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be adapted to perform functions and/or features that may be associated with various software elements described throughout.

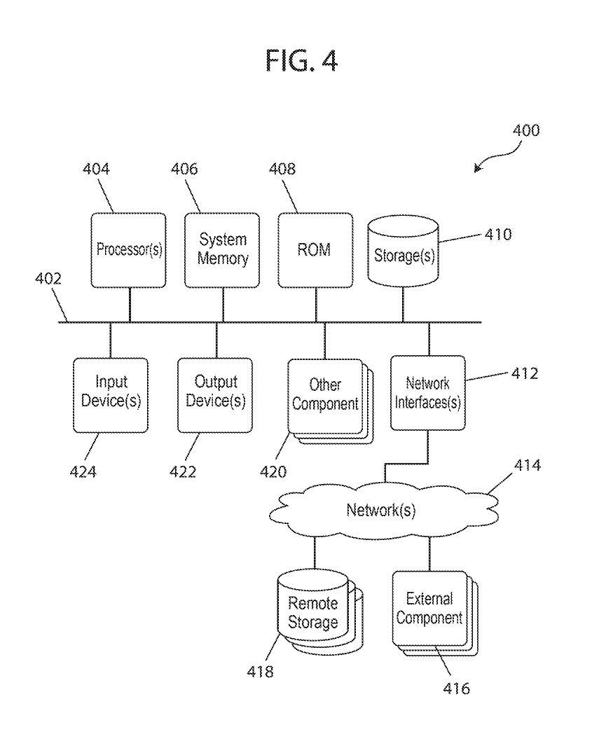

Referring to the drawings, FIG. 4 illustrates a schematic block diagram of a conceptual computer system 400 used to implement some embodiments. For example, the system described above in reference to FIGS. 1-3 may be at least partially implemented using all or a portion of computer system 400.

Computer system 400 may be implemented using various appropriate devices. For instance, the computer system may be implemented using one or more vehicle display units, personal computers (PCs), servers, mobile devices (e.g., a smartphone), tablet devices, and/or any other appropriate devices. The various devices may work alone (e.g., the computer system may be implemented as a vehicle display unit) or in conjunction (e.g., some components of the computer system may be provided by a vehicle display unit while other components may be provided by a tablet device).

As shown, computer system 400 may include at least one communication bus 402, one or more processors 404, a system memory 406, a read-only memory (ROM) 408, permanent storage devices 410, input devices 424, output devices 422, various other components 420 (e.g., a graphics processing unit), and one or more network interfaces 412 and may include a network 414, corresponding remote storage 418 and a corresponding external component 416.

Bus represents all communication pathways among the elements of computer system 400. Such pathways may include wired, wireless, optical, and/or other appropriate communication pathways. For example, input devices 424 and/or output devices 422 may be coupled to the system 400 using a wireless connection protocol or system.

The processor 404 may, in order to execute the processes of some embodiments, retrieve instructions to execute and/or data to process from components such as system memory 406, ROM 408, and permanent storage device 410. Such instructions and data may be passed over bus 402.

System memory 406 may be a volatile read-and-write memory, such as a random access memory (RAM). The system memory may store some of the instructions and data that the processor uses at runtime. The sets of instructions and/or data used to implement some embodiments may be stored in the system memory 406, the permanent storage device 410, and/or the read-only memory 408. ROM 408 may store static data and instructions that may be used by processor 404 and/or other elements of the computer system.

Permanent storage device 410 may be a read-and-write memory device. The permanent storage device may be a non-volatile memory unit that stores instructions and data even when computer system 400 is off or unpowered. Computer system 400 may use a removable storage device and/or a remote storage device as the permanent storage device.

Input devices 424 may enable a user to communicate information to the computer system and/or manipulate various operations of the system. The input devices may include keyboards, cursor control devices, audio input devices and/or video input devices. Output devices 422 may include printers, displays, and/or audio devices. Some or all of the input and/or output devices may be wirelessly or optically connected to the computer system.

Other components 420 may perform various other functions. These functions may include performing specific functions (e.g., graphics processing, sound processing, etc.), providing storage, interfacing with external systems or components, etc.

Referring to FIG. 4, computer system 400 may be coupled to one or more networks 414 through one or more network interfaces 412. For example, computer system 400 may be coupled to a web server on the Internet such that a web browser executing on computer system 400 may interact with the web server as a user interacts with an interface that operates in the web browser. Computer system 400 may be able to access one or more remote storages 418 and one or more external components 416 through the network interface 412 and network 414. The network interface(s) 412 may include one or more application programming interfaces (APIs) that may allow the computer system 400 to access remote systems and/or storages and also may allow remote systems and/or storages to access computer system 400 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 400 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

### Definitions

For the purposes of the present disclosure, certain terms used herein may also be found in other fields as apparent to a person skilled in the art. For this reason, such terms used herein should not be taken as to limit the scope of the present disclosure and includes all other types of objects or related fields with which the present disclosure may be used and may be useful.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. As used herein, the term “comprising” means including elements or steps that are identified following that term, but any such elements or steps are not exhaustive, and an embodiment can include other elements or steps.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

While certain embodiments have been illustrated and described, it should be understood that changes and modifications can be made therein in accordance with ordinary skill in the art without departing from the technology in its broader aspects as defined in the following claims.

The present disclosure is not to be limited in terms of the particular embodiments described in this application. Many modifications and variations can be made without departing from its spirit and scope, as will be apparent to those skilled in the art. Functionally equivalent methods and devices within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or devices, which can of course vary. It is also to be understood that the terminology used herein is for the purpose of describing particular embodiments only, and is not intended to be limiting.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict any definitions in this disclosure.

What is claimed is:

1. A method for collecting and reporting media information, comprising:
a) receiving one or more media resources by a media computing platform from one or more content owner devices;
b) consuming one or more media resources via the media computing platform and one or more user devices;
c) computing media time duration consumption data by the media computing platform independently for each one or more media resources consumed by each one or more user devices of Step b), wherein computing by a processor derives an independent time duration measure of a user's consumption of each media resource;
d) reporting media time duration consumption data by the media computing platform independently for each one or more media resources consumed by each one or more user devices of Step c);
e) receiving a media rating by the media computing platform for each one or more media resources consumed by each one or more user devices of Step d);
f) reporting the media rating by the media computing platform for each one or more media resources consumed by each one or more user devices of Step e);
g) calculating an enjoyment score by the media computing platform from the media time duration consumption data of Step d) and the media rating of Step f) independently for each one or more media resources consumed by each one or more content owner devices;
h) calculating a media payout by the media computing platform for each content owner for each one or more media resources from the enjoyment score of Step f); and
i) reporting the media payout by the media computing platform for each content owner's one or more media resources from the calculated media payout of Step h).

2. The method of claim 1, further comprising the step of receiving a user's registration and subscription fee.

3. The method of claim 1, further comprising the step of calculating a media platform payout by the media computing platform derived from a percentage of a user's subscription fee.

4. The method of claim 1, wherein the media resource is selected from video files, audio files and/or video games.

5. The method of claim 1, wherein the media resource is a television program, movie, audio book and/or video game.

6. The method of claim 1, wherein the device comprises a set-top box coupled to a respective television unit, desktop computer, cell phone, computer tablet and/or a smart television.

7. The method of claim 1, wherein the consumer media consumption and rating functionality is configured to generate media time duration consumption data in the form of one or more time segments of one or more media resources consumed by one or more users.

8. The method of claim 7, wherein the one or more time segments are calculated in milliseconds, seconds, minutes, hours, or a combination thereof.

9. The method of claim 1, wherein the consumer media consumption and rating functionality is configured to receive media ratings in the form of a numerical rating from one or more users for one or more media resources.

10. The method of claim 9, wherein the numerical rating is between 1 and 100.

11. The method of claim 1, wherein the media computing platform is configured for receiving and reporting via a network to a remote operator or a user.

12. The method of claim 11, further comprising one or more machine readable storage media storing machine readable instructions for implementing the functionality of claim 1.

13. A system for collecting and reporting media information, comprising:
a) a processor;
b) a storage device; and
c) a media computing platform, comprising:
i. a consumer media consumption and rating functionality configured to be operated by the processor and stored on the storage device for computing and reporting media time duration consumption data for one or more media resources for one or more users, and for receiving and reporting a media rating for one or more media resources from one or more users; and
ii. a content owner media payout functionality configured to be operated by the processor and stored on the storage device for computing and reporting one or more media payouts determined by a media enjoyment score derived from the consumer media consumption and rating functionality.

14. The system of claim 13, wherein the media resource is selected from video files, audio files and/or video games.

15. The system of claim 13, wherein the media resource is a television program, movie, audio book and/or video game.

16. The system of claim 13, wherein the device comprises a set-top box coupled to a respective television unit, desktop computer, cell phone, computer tablet and/or a smart television.

17. The system of claim 13, wherein the consumer media consumption and rating functionality is configured to generate media time duration consumption data in the form of one or more time segments of one or more media resources consumed by one or more users.

18. The system of claim 13, wherein the consumer media consumption and rating functionality is configured to receive media ratings in the form of a numerical rating from one or more users for one or more media resources.

19. The system of claim 13, wherein the media computing platform is configured for receiving and reporting via a network to a remote operator or user.

20. The system of claim 19, further comprising one or more machine readable storage media storing machine readable instructions for implementing the functionality of claim 13.
